(19) United States
(12) Patent Application Publication
(10) Pub. No.: US 2008/0294980 A1
(43) Pub. Date: Nov. 27, 2008

(54) Methods and Devices for Compressing and Decompressing Structured Documents

(75) Inventors: Cedric Thienot, Paris (FR); Philippe De Cuetos, Paris (FR); Robin Berjon, Paris (FR)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: EXPWAY, Reims (FR)

(21) Appl. No.: 11/996,423

(22) PCT Filed: Jul. 20, 2006
(86) PCT No.: PCT/IB06/03377

§ 371 Date: Jul. 3, 2008

(30) Foreign Application Priority Data
Jul. 21, 2005 (US) 60701030

(51) Int. Cl. G06F 17/00

(52) U.S. Cl. 715/242

(57) ABSTRACT

The invention relates to a method of compressing a structured document having a tree-like structure comprising elements nested in each other, each element comprising attributes and a value field which may comprise other elements, the method comprising defining a simplified type comprising only a part of attributes of an original type, and for each element of the original type, replacing the type identifier in the element with an identifier of the simplified type when the element differs from a previous element having the original type only in the attribute values or presences of the simplified type attributes.

### CROSS-REFERENCE TO RELATED APPLICATIONS

This application is a Section 371 of International Application No. PCT/IB2006/003377, filed Jul. 20, 2006, which was published in the English language on Mar. 8, 2007, under International Publication No. WO 2007/026258 A2 and the disclosure of which is incorporated herein by reference.

### BACKGROUND OF THE INVENTION

The present invention relates in general to the field of computer systems for transmitting, storing, retrieving and displaying data. It more particularly relates to a method and system for compressing and decompressing structured documents comprising a high number of structured elements having many attributes and/or subelements.

It applies particularly but not exclusively to handling, transmitting, storing, and reading structured multimedia documents, digital or video images or image sequences, movies or video programs, and more generally to any transfer of said documents between processor units interconnected by data transmission networks, or between a processor unit and a storage unit, or indeed between a processor unit and a playback unit such as a television set if the document contains digital or video images.

More and more frequently, documents handled and transmitted in this way contain a plurality of different types of data integrated in a structure. A structured document is a set of information elements each associated with a type and attributes, and interconnected by relationships that are mainly hierarchical. Such documents use a markup language such as Standard Generalized Markup Language (SGML), Hypertext Markup Language (HTML), or Extensible Markup Language (XML), serving in particular to distinguish between the various elements of information making up the document. In contrast, in a “linear” document, the content information of the document is mixed in with layout information and type information.

A structured document includes markers also called “tags” for separating different information element in the document. For SGML, XML, or HTML formats, these tags have the form “<XXXX>” and “</XXXX>”, the first tag “XXXX” marking the beginning of an information element, and the second tag “</XXXX>” marking the end of said element. An information element may itself be made up of a plurality attributes and lower-level information elements also called “subelements”. Thus, a structured document presents a tree or hierarchical structure, each node representing an information element and being connected to a node at a higher hierarchical level representing an information element that contains the information elements at lower level. The nodes located at the ends of branches in such a tree structure represent information elements containing data of a predetermined unstructured type, which is not divided into information subelements.

Thus, a structured document contains separation markers or tags generally represented in textual form, said tags defining information elements or subelements that can themselves contain other information subelements separated by tags.

However markup languages such a XML are verbose languages and thus they are inefficient to be processed and costly to be transmitted or stored. In addition, many software applications tend to produce very large structured documents. This is particularly the case of software applications creating HTML documents and digital graphical documents such as scene description, art, technical drawings, schematics and the like. The documents produced by graphical applications include graphical data describing a large number of points, lines and curves. In these graphical documents, graphical objects are described by graphical structured elements using a language such as SVG (Scalable Vector Graphics) describing two-dimensional vector and mixed vector/raster graphic objects.

Since structured documents are intended to be stored or transmit through digital network, there is a need for reducing the size of such structured documents.

A known solution to reduce the size of structured document is to apply a compression process to the document. In this respect, ISO/IEC 15938-1 (MPEG-7—Moving Picture Expert Group) or more recently ISO/IEC 23001-1 proposes a method and a binary format for encoding (compressing) a XML structured document and decoding such a binary format. This standard is more particularly designed to deal with highly structured data, such as multimedia metadata.

However some structured elements have typically a large number of mandatory or optional attributes and/or subelements, while in practice few of them are present in the documents. When such a structured element is compressed into a binary stream, each attribute or subelement not present in the element should be encoded at least into a binary flag indicating the absence of the attribute or element. Thus the binary encoding of a structured document having a large number of attributes or subelements is not efficient.

### BRIEF SUMMARY OF THE INVENTION

One embodiment of the present invention reduces the size of structured documents binary encoded using MPEG-7, based on the observation that many documents have a high number of elements of the same type that differ only in a small number of attributes or subelements.

Thus one embodiment of the present invention provides a compression method of compressing a structured document having a tree-like structure comprising structured elements nested in each other and each associated with an element type identifier referencing a structure of the information element, each element comprising according to the type of the element, attributes defined by a name and a value, and a value field which may comprise one or more elements. According to one embodiment of the invention, the compression method comprises steps of:

defining a simplified element type derived from an original element type and comprising only a part of attributes and value field of the original type, and

for each element having the original type in the document, replacing the type identifier of the element with an identifier of the simplified type when the element differs from a previous element having the original type in the document only in the value or presence of each of the attributes and the element value field of the simplified type, and removing from the element the attributes and value field that do not belong to the simplified type.

According to one embodiment of the invention, the compression method comprises an encoding step providing a binary stream from the structured document.

According to one embodiment of the invention, the binary stream comprises for each element of the structured document:

a binary number indicating the type identifier of the element, and

a compressed binary value encoding the value of each of the attributes of the element and the value field of the element, comprising for each optional attribute and value field of the element a bit indicating whether the attribute or value field is present or not.

According to one embodiment of the invention, the step of type replacement is performed before the encoding step.

According to one embodiment of the invention, the simplified type comprises attributes whose value or presence is varying frequently in the elements of the original type in the document.

According to one embodiment of the invention, several simplified types are defined for a same original type of the structured document, the simplified types having different attributes.

According to one embodiment of the invention, the compression method comprises steps of defining a derived type based on an original type and comprising an optional set of attributes including optional attributes of the original type, and replacing the original type of each element of the structured document having the original type with the derived type.

Another embodiment of the present invention provides a decompression method of decompressing a structured document in the form of a binary stream, the structured document having a tree-like structure comprising information elements nested in each other and each associated with an element type identifier referencing a structure of the information element, each element comprising according to the type of the element attributes defined by a name and a value, and a value field which may comprise one or more elements.

According to one embodiment of the invention, at least one element has a simplified type derived from an original type and comprising only a part of attributes and value field of the original type, the values of the attributes and value field not belonging to the simplified type being given by a previous element in the document having the original type.

According to one embodiment of the invention, the binary stream comprises a binary encoded value for each element of the structured document, each element binary encoded value comprising:

a binary number indicating the type identifier of the element, and

a compressed binary value encoding the value of each of the attributes of the element and the value field of the element, comprising for each optional attribute and value field of the element a bit indicating whether the attribute and or value field of the element is present or not.

According to one embodiment of the invention, the decompression method comprises a step of decoding the binary stream by converting the binary numbers and values into element type identifiers, attribute names and values, and element values.

According to one embodiment of the invention, the decompression method comprises steps of replacing each simplified type identifier in the document with the corresponding original type identifier, and inserting in each element having a simplified type attributes and value of a previous element having the original type, that do not belong to the simplified type.

According to one embodiment of the invention, the step of replacement if perform after the decoding step.

According to one embodiment of the invention, the simplified type comprises attributes whose presence or value is varying frequently in the elements having the original type in the document.

According to one embodiment of the invention, several simplified types are defined for a same original type of the structured document, the simplified types having different attributes.

According to one embodiment of the invention, at least one element has an original type replaced with a derived type comprising an optional set of attributes including optional attributes of the original type, the binary stream encoding the document comprising for each element having the derived type a bit indicating whether one or more attributes of the optional attribute set is present or absent in the element.

According to one embodiment of the invention, the decompression method comprises steps of replacing the derived type identifier by the corresponding original type identifier.

Another embodiment of the present invention provides a compression device for compressing a structured document having a tree-like structure comprising information elements nested in each other and each associated with an element type identifier referencing a structure of the information element, each element comprising according to the type of the element mandatory or optional attributes defined by a name and a value, and an optional value field which may comprise one or more elements,

According to one embodiment of the invention, a simplified type derived from an original type in the structured document and comprising only a part of attributes and value field of the original type is defined, the compression device being configured to:

replace in the document the type identifier of each element having the original type with an identifier of the simplified type when the element differs from a previous element in the document having the original type only in the values of the attributes and the element value field of the simplified type, and

remove from each element having the simplified type the attributes and value field that do not belong to the simplified type.

According to one embodiment of the invention, the compression device is configured so as to provide a binary stream.

According to one embodiment of the invention, the binary stream comprises for each element of the structured document:

a binary number indicating the type identifier of the element, and

a compressed binary value encoding the value of each of the attributes of the element and the value field of the element, comprising for each optional attribute and value field of the element a bit indicating whether the attribute or value field is present or not.

According to one embodiment of the invention, the compression device is configured to replace original types by simplified types in the structured document before encoding the structured document.

According to one embodiment of the invention, the simplified type comprises attributes whose presence or value is varying frequently in the elements having the original type in the document.

According to one embodiment of the invention, several simplified types are defined for a same original type of the structured document, the simplified types having different attributes.

According to one embodiment of the invention, a derived type based on an original type and comprising an optional set of attributes including optional attributes of the original type is defined, the compression device being configured to replace the original type of each element of the structured document having the original type with the derived type.

Another embodiment of the present invention provides a decompression device for decompressing a structured document in the form of a binary stream, the structured document having a tree-like structure comprising information elements nested in each other and each associated with an element type identifier referencing a structure of the information element, each element comprising according to the type of the element attributes defined by a name and a value, and a value field which may comprise one or more elements,

According to one embodiment of the invention, at least one element has a simplified type derived from an original type and comprising only a part of attributes and value field of the original type, the values of the attributes and value field not belonging to the simplified type being given by a previous element in the document having the original type.

According to one embodiment of the invention, the binary stream comprises a binary encoded value for each element of the structured document, each element binary encoded value comprising:

a binary number indicating the type identifier of the element, and

a compressed binary value encoding the value of each of the attributes of the element and the value field of the element, comprising for each optional attribute and value field of the element a bit indicating whether each attribute and the value field of the element is present or not.

According to one embodiment of the invention, the decompression device comprises a decoder configured to decode the binary stream by converting the binary numbers and values into element type identifiers, attribute names and values, and element values,

According to one embodiment of the invention, decompression device is configured to replace each simplified type identifier in the document with the corresponding original type identifier, and insert in each element having the simplified type identifier attributes and value of a previous element having the original type, that do not belong to the simplified type.

According to one embodiment of the invention, the decompression device is configured to replace the simplified type identifiers with the corresponding original type after decoding the binary stream.

According to one embodiment of the invention, the simplified type comprises attributes whose presence or value is varying frequently in the elements of the original type in the document.

According to one embodiment of the invention, several simplified types are defined for a same original type of the structured document, the simplified types having different attributes.

According to one embodiment of the invention, at least one element has an original type replaced with a derived type comprising an optional set of attributes including optional attributes of the original type, the binary stream encoding the document comprising for each element having the derived type a bit indicating whether one or more attributes of the optional attribute set is present or absent in the element.

According to one embodiment of the invention, the decompression device is configured to replace the derived type identifier by the corresponding original type identifier.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 represents in block form a structured document,

FIG. 2 represents in block form a structured document compression device according to one embodiment of the present invention,

FIG. 3 represents in block form a structured document decompression device according to one embodiment of the present invention,

FIG. 4 is a flow chart of an optimization procedure executed by the compression device of FIG. 2,

FIG. 5 is a flow chart of an adaptation procedure executed by the decompression device of FIG. 3.

### DETAILED DESCRIPTION OF THE INVENTION

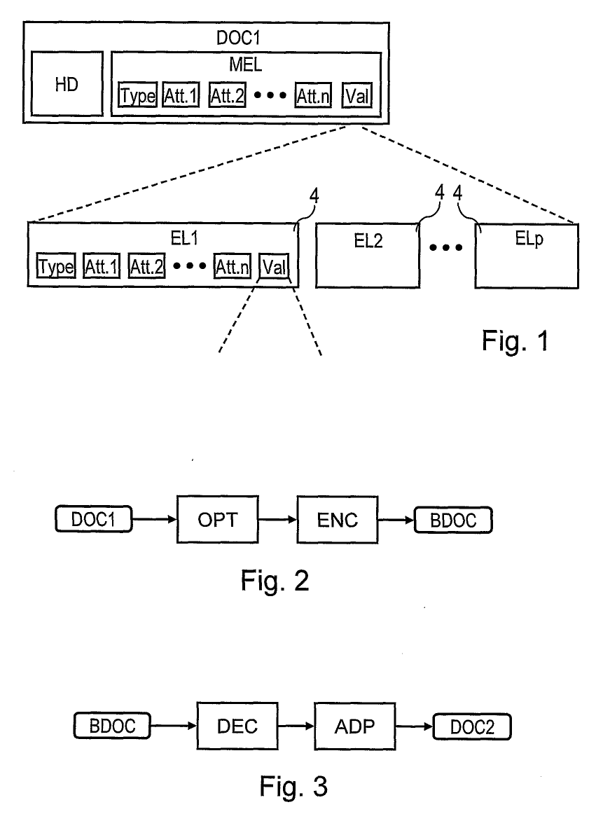

FIG. 1 represents a structured document 1 comprising a header HD and a main element MEL. The main element MEL comprises a type identifier Type, a set of attributes Att.1, Att.2, . . . Att.n and a value Val. The value of the main element MEL may include one or more structured elements 4 called “subelements of the main element”, each comprising a type identifier Type, a set of attributes Att.1-Att.n and a value Val. The value of each element 4 may itself also include one or more structured or unstructured subelements. The unstructured elements have a known format such as string, integer number, floating-point number, . . . . Each element or subelement is associated with a type defining the structure of the element. Each type of the elements of a structured document may be defined in a schema (for example XML schema in XML language).

A structured element of a structured document has the following form in XML, or in languages derived from XML such as HTML and SVG:

<type att1-name=“att1-value” att2-name=“att2-value” ...

attn-name =“attb-value”>value</type>

where “<type . . . >” is a beginning tag delimiting the beginning of the element in the document,

“type” is a type identifier of the structured element,

“</type>” is an end tag delimiting the end of the element in the document,

“atti-name=atti-value” are the name of the attribute “i” of the element, and the value of the attribute, and

value is the value of the element which may comprise structured or unstructured subelements.

The following is an example of a HTML element of the type “a” (HTML anchor type):

<a att1-name=“att1-value” att2-name=“att2-value” ...

attn-name=“attb-value”>value</a>

An HTML anchor element may comprise the following 29 optional attributes:

| | | |
|---|---|---|
| href | charset | type |
| name | hreflang | rel |
| rev | accesskey | shape |
| coords | tabindex | id |
| lang | dir | title |
| style | onfocus | onblur |
| onclick | ondblclick | onmousedown |
| onmouseup | onmouseover | onmousemove |
| onmouseout | onkeypress | onkeydown |
| onkeyup | target | |

An anchor element with attributes “id” and “href” is encoded according to ISO-IEC 23001-1 as follows:

bit(n)=a-num // a-num is a binary number coded with n bits referencing
the type “a”,
bit(1)=1// bit indicating the presence of attribute “id”
ID-value// value of the attribute “id”
bit(1)=1// bit indicating the presence of attribute “href”
href-value// value of the attribute “href”
bit(1)=0// bit indicating the absence of attribute “charset”
bit(1)=0// bit indicating the absence of attribute “type”
......
bit(1)=0// bit indicating the absence of attribute “target”
bit(1)=0/1// bit indicating the absence/presence of a value of the anchor
element
anchor-value// value of the anchor element if it has a value.

In the binary stream generated by a ISO-IEC 23001-1 compliant encoder, the encoded value of each element of the structured document appears in a predetermined order corresponding to the apparition order of the element in the structured document. Each element is encoded with a bit number “a-num” indicating the type of the element. Each attribute of the element in encoded in a predetermined order. Each mandatory attribute of the element is encoded with a compressed binary value representing the value of the attribute. Each optional attribute of the element is encoded with a bit indicating whether the attribute is present or not, followed by a binary compressed value representing the value of the attribute. If the value of the element is optional, it is encoded with a bit indicating whether the value of the element is present or not, followed by an encoded value of the element. If the value of the element is composed of structured subelements, each subelement is encoded as an element. Otherwise, the value of the element is encoded with a binary compressed value representing the value of the element.

SVG is another language based on XML. SVG is designed to describe graphical objects such as scene descriptions. This language also comprises many element types having a high number of possible attributes. For example, the element type “polygon” comprises the following 60 attributes:

| | | |
|---|---|---|
| audio-level | Class | color |
| color-rendering | Display | display-align |
| fill | fill-opacity | fill-rule |
| nav-right | nav-next | nav-up |
| nav-up-right | nav-up-left | nav-prev |
| nav-down | nav-down-right | nav-down-left |
| nav-left | Focusable | font-family |
| font-size | font-style | font-variant |
| font-weight | Id | image-rendering |
| line-increment | lsr:rotation | lsr:scale |
| lsr:translation | pointer-events | points |
| requiredExtensions | requiredFeatures | requiredFormats |
| shape-rendering | solid-color | solid-opacity |
| stop-color | stop-opacity | stroke |
| stroke-dasharray | stroke-dashoffset | stroke-linecap |
| stroke-linejoin | stroke-miterlimit | stroke-opacity |
| stroke-width | systemLanguage | text-anchor |
| text-rendering | Transform | vector-effect |
| viewport-fill | viewport-fill-opacity | visibility |
| xml:base | xml:lang | xml:space |

All these attributes are optional except “points” which gives a list of point coordinates of the polygon. Generally, the most frequently-used optional attributes are “id” and “fill”. A polygon element having an identifier “ID” and a list of points (mandatory) is encoded according to ISO-IEC 23001-1 as follows:

| | |
|---|---|
| bit(6)=p-num | // p-num is a binary number coded with 6 bits referencing |
| | the type polygon |
| bit(1)=1 | // bit indicating the presence of attribute “id” |
| ID-value | // value of the attribute “id” |
| Points | // list of point coordinates of the polygon |
| bit(1)=0 | // bit indicating the absence of attribute “fill” |
| bit(1)=0 | // bit indicating the absence of attribute “audio-level” |
| bit(1)=0 | // bit indicating the absence of attribute “class” |
| ... | ... |
| bit(1)=0 | // bit indicating the absence of attribute “xml:space” |
| bit(1)=0/1 | // bit indicating the absence/presence of a value of the |
| | polygon element |
| polygon-value | // value of the polygon element if it has a value. |

Therefore, the encoded value of an anchor or polygon element comprises one bit to 0 for each absent optional attribute and one bit to 1 for each present optional attribute, followed by the value of the present attribute. Thus the encoding of an element having a high number of optional attributes is not efficient in term of compression ratio.

According to one embodiment of the invention, new simplified element types are introduced. In the example of the “polygon”-type element, a new element type “samepolygon” is introduced, this new element type having only the mandatory attributes of “polygon” type, namely “point” and the most frequently changed attributes (with respect to their value or presence) of this element type, namely “id”. All the other attributes values of a “polygon” element are specified by another “polygon” element previously appearing in the document.

When a second “polygon” element appears in a SVG document after a first previous element of the same type and having the same attributes with the same values except for the attributes “points” and “id”, the second “polygon” element is replaced with an element of the type “samepolygon”. When changing the element type of the second “polygon” element, all the attributes that do not belong to the simplified type are removed (they have the same values as in the previous element of the same type). Thus the second “polygon” element will be encoded as follows:

bit(6)=p1-num// p1-num is a binary number coded with 6 bits

| | |
|---|---|
| | referencing the type “samepolygon” |
| bit(1)=1 | // bit indicating the presence of attribute “id” |
| ID-value | // value of the attribute “id” |
| Points | // list of point coordinates of the polygon |
| bit(1)=0/1 | // bit indicating the absence/presence of a value |
| | of the “polygon” element |
| polygon-value | // value of the “polygon” element if it has a value. |

In a same manner, a type “Samea” is defined with only one attribute “href”. All anchor type elements following a first anchor element having only a different “href” attribute value are encoded in the following manner:

| | |
|---|---|
| bit(n)=a1-num | // a1-num is a binary number coded with n bits |
| | referencing the type “Samea” |
| href-value | // value of the attribute “href” |
| bit(1)=0/1 | // bit indicating the absence/presence of a value |
| | of the “anchor” element |
| anchor-value | // value of the “anchor” element if it has a value. |

Thus, according to an embodiment of the present invention, several complex element types having a high number of attributes or very frequently used types with only one or two attributes varying by their value and/or presence are replaced in the structured document with simplified element types having as attributes only the varying attributes used in the document. The definition of simplified types can be based on a statistical analysis of structured documents associated with a same structure schema.

Note that the “samepolygon” or “samea” type may be defined with a mandatory value field if most of the polygon or anchor elements of the document have a value. In this case, an encoded element of the type “samepolygon” or “samea” does not comprise a bit indicating the absence/presence of such a value. In an analog manner, the value of an element is associated with an element type. If most of the polygon or anchor element values of the document have a given type, the type “samepolygon” or “samea” may impose a type for the value of an element of the type “samepolygon” or “samea”. Thus, the encoded value of the element does not comprise a binary number referencing the element type of the value.

Several simplified element types may be defined from a single element type, for example when elements of the document having the same type have two or three attributes varying by their value or presence. Thus in the above example, a type “samepolygonfill” may be added to define an element having the three attributes: “id”, “point” and “fill”. The type “samepolygonfill” can replace the type “polygon” of an element in the document differing from a previous “polygon” element only in the values of the attributes “fill”, “point” and “id”.

FIG. 2 represents a compressing device according to an embodiment of the invention. The compressing device comprises an optimizer OPT receiving a structured document DOC1 to be encoded, and an encoder ENC converting the optimized structured document into a binary stream BDOC. The optimizer is adapted to replace in the structured document DOC 1 the types “X” of the elements having repetitive attribute values with simplified types “SameX” according to an embodiment of the invention.

FIG. 3 represent a decompressing device according to an embodiment of the invention. The decompressing device comprises a decoder DEC converting a binary stream BDOC into an optimized structured document. If the application reading or using the structured document does not know the simplified types “SameX”, the decoding device comprises an adapter ADP for converting the simplified types into original types and adding to the elements having the simplified types previously defined attribute values. The adapter ADP provides a structured document DOC2 which is similar to the document applied to the encoder ENC, but not necessarily the same.

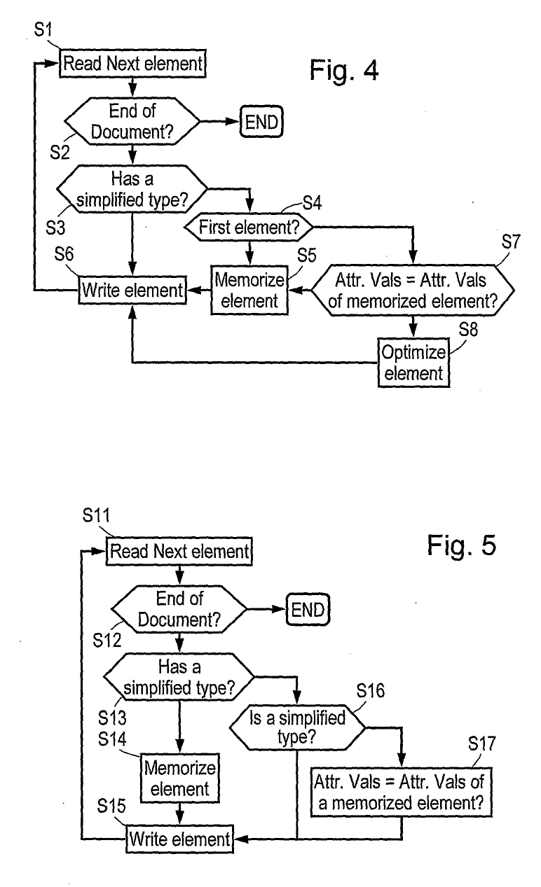

FIG. 4 represents processing steps performed by the optimizer OPT. The processing steps of FIG. 4 comprise steps S1-S8. At step S1, the structured document is read element by element until the end of the document is reached (step S2). Steps S3 to S8 are executed for each element of the document.

At step S3, the optimizer OPT determines whether the element type of the current element read has one simplified type. If the type of the current element read has no simplified type, the current element is written in a resulting document (step S6). If the type of the current element read has one or more simplified types, the optimizer OPT determines if a previous element having a same type in the document is memorized (step S4). If an element of the same type as the current element is not already memorized, the element is memorized at step S5 and the element is written in the resulting document at step S6. At step S4, if the current element has a type of an element previously memorized, the optimizer determines at step S7 whether the type of the current element can be replaced with a simplified type. In other words, the optimizer determines at step S7 whether the attributes values of the current element are equal to the attribute values of the memorized element except for the attributes of the simplified type. If the current element type can be replaced with a simplified type, the element is written in the resulting document with the simplified type identifier (step S8). In addition all attributes of the element that do not belong to the simplified type are removed from the element written in the resulting document. Otherwise, the element is written without any change in the resulting document with its current type identifier (step S6).

FIG. 5 represents processing steps performed by the adapter ADP. The processing steps of FIG. 5 comprise steps S11-S17. At step S11, the document is read element by element until the end of the document is reached (step S12).

At step S13, the adapter ADP determines whether the element type of the current element read is a type having a simplified type. If the type of the current element read is a type having one or more simplified types, the adapter ADP memorizes the current element at step S14 and writes the current element in the resulting document at step S15. Otherwise, the adapter ADP determines whether the type of the current element is a simplified type (Step S16). If the type of the current element is a simplified type, the current element is transformed at step S17 into a new element having a type identifier corresponding to that of an original type from which the simplified type is derived. The new element has the attributes of the current element and other attributes of a previously memorized element having the same original type.

If at step S16 the type of the current element is not a simplified type, the current element is written in the resulting document at step S15.

It should be noted that the optimized document provided by the optimizer has a smaller size than the original document DOC1. Therefore, the optimized document may be used (stored, transmitted, . . . ) without being encoded into a binary stream. Thus, in the compression device of FIG. 2, the encoder ENC is not necessary, and therefore the decoder DEC of the decompression device of FIG. 3 is not necessary.

In addition the optimized document may be compressed using other compression algorithms such as ZLIB. If the encoder ENC applies another compression algorithm to the document DOC1, the decoder applies to the binary stream CDOC a reverse algorithm so as to obtain a structured document DOC2 which is equivalent to the original document DOC1.

According to another embodiment of the invention, a structured document is optimized in term of compression ratio by defining a new attribute type including a set of rare optional attributes and by modifying the element types including the rare optional attributes so as to introduce the new attribute type in the place of all the attributes included in the new attribute type. In this manner, most of the elements of the document having a high number of attributes can be encoded as in the following example of “polygon” type:

| | |
|---|---|
| bit(6)=p-num | // p-num is a binary number coded with 6 bits |
| | referencing the type “polygon” |
| bit(1)=0/1 | // bit indicating the absence/presence of attribute “id” |
| ID-value | // value of the attribute “id” if it is present |
| Points | // list of point coordinates of the polygon |
| bit(1)=0 | // bit indicating the absence of attributes belonging |
| | to the rare attributes set |
| bit(1)=0/1 | // bit indicating the absence/presence of a value for |
| | the “polygon” element |
| polygon-value | // value of the “polygon” element if it is present. |

If an attribute belonging to the rare attribute set is present in the element, the encoded element is not optimized and comprises an additional bit indicating the presence of an attribute belonging to the rare attribute set.

This optimization applies in particular to the element types having simplified types.

In the light of the examples described above, it will be clear to those skilled in the art that the method and device according to the invention are susceptible to several variations of implementations. In particular, the invention is not limited to XML language or derived XML languages such as HTML or SVG. The invention more generally applies to all structure languages.

The invention is not limited to attributes of structured elements, the invention more generally applies to subelements of structured elements. Thus if several elements of a given type have in the structured document all a same value field, a simplified type “sameX” having a fixed value field (defined by a previous element of the type “X”) can be defined and used to simplify the encoding of the element.

The step of replacing types of elements with simplified types may also be performed on the binary stream encoding the structured document, or while encoding or decoding the document.

In the decompression method, it is not necessary to replace the simplified types with their corresponding original types. Indeed, the application using the decoded structured document may understand the simplified and derived type identifiers.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A compression method of compressing a structured document having a tree-like structure comprising structured elements nested in each other and each associated with an element type identifier referencing a structure of the information element, each element comprising according to the type of the element, attributes defined by a name and a value, and a value field which may comprise one or more elements,
the method comprises:
defining a simplified element type derived from an original element type and comprising only a part of attributes and value field of the original type, and
for each element having the original type in the document, replacing the type identifier of the element with an identifier of the simplified type when the element differs from a previous element having the original type in the document only in the value or presence of each of the attributes and the element value field of the simplified type, and removing from the element the attributes and value field that do not belong to the simplified type.

2. The compression method according to claim 1, comprising an encoding step providing a binary stream from the structured document.

3. The compression method according to claim 2, wherein the binary stream comprises for each element of the structured document:
a binary number indicating the type identifier of the element, and
a compressed binary value encoding the value of each of the attributes of the element and the value field of the element, comprising for each optional attribute and value field of the element a bit indicating whether the attribute or value field is present or not.

4. The compression method according to claim 2, wherein the step of type replacement is performed before the encoding step.

5. The compression method according to claim 1, wherein the simplified type comprises attributes whose value or presence is varying frequently in the elements of the original type in the document.

6. The compression method according to claim 1, wherein several simplified types are defined for a same original type of the structured document, the simplified types having different attributes.

7. The compression method according to claim 1, comprising steps of defining a derived type based on an original type and comprising an optional set of attributes including optional attributes of the original type, and replacing the original type of each element of the structured document having the original type with the derived type.

8. A decompression method of decompressing a structured document in the form of a binary stream, the structured document having a tree-like structure comprising information elements nested in each other and each associated with an element type identifier referencing a structure of the information element, each element comprising according to the type of the element attributes defined by a name and a value, and a value field which may comprise one or more elements,
characterized in that at least one element has a simplified type derived from an original type and comprising only a part of attributes and value field of the original type, the values of the attributes and value field not belonging to the simplified type being given by a previous element in the document having the original type.

9. The decompression method according to claim 8, wherein the binary stream comprises a binary encoded value for each element of the structured document, each element binary encoded value comprising:
a binary number indicating the type identifier of the element, and
a compressed binary value encoding the value of each of the attributes of the element and the value field of the element, comprising for each optional attribute and value field of the element a bit indicating whether the attribute and or value field of the element is present or not.

10. The decompression method according to claim 8, comprising a step of decoding the binary stream by converting the binary numbers and values into element type identifiers, attribute names and values, and element values.

11. The decompression method according to claim 8, comprising steps of replacing each simplified type identifier in the document with the corresponding original type identifier, and inserting in each element having a simplified type attributes and value of a previous element having the original type, that do not belong to the simplified type.

12. The decompression method according to claim 11, wherein the step of replacement if perform after the decoding step.

13. The decompression method according to claim 8, wherein the simplified type comprises attributes whose presence or value is varying frequently in the elements having the original type in the document.

14. The decompression method according to claim 8, wherein several simplified types are defined for a same original type of the structured document, the simplified types having different attributes.

15. The decompression method according to claim 8, wherein at least one element has an original type replaced with a derived type comprising an optional set of attributes including optional attributes of the original type, the binary stream encoding the document comprising for each element having the derived type a bit indicating whether one or more attributes of the optional attribute set is present or absent in the element.

16. The decompression method according to claim 15, comprising steps of replacing the derived type identifier by the corresponding original type identifier.

17. A compression device for compressing a structured document having a tree-like structure comprising information elements nested in each other and each associated with an element type identifier referencing a structure of the information element, each element comprising according to the type of the element mandatory or optional attributes defined by a name and a value, and an optional value field which may comprise one or more elements,
a simplified type being derived from an original type in the structured document and comprising only a part of attributes and value field of the original type being defined, the compression device being configured to:
replace in the document the type identifier of each element having the original type with an identifier of the simplified type when the element differs from a previous element in the document having the original type only in the values of the attributes and the element value field of the simplified type, and
remove from each element having the simplified type the attributes and value field that do not belong to the simplified type.

18. The compression device according to claim 17, configured so as to provide a binary stream.

19. The compression device according to claim 18, wherein the binary stream comprises for each element of the structured document:
a binary number indicating the type identifier of the element, and
a compressed binary value encoding the value of each of the attributes of the element and the value field of the element, comprising for each optional attribute and value field of the element a bit indicating whether the attribute or value field is present or not.

20. The compression device according to claim 18, configured to replace original types by simplified types in the structured document before encoding the structured document.

21. The compression device according to claim 17, wherein the simplified type comprises attributes whose presence or value is varying frequently in the elements having the original type in the document.

22. The compression device according to claim 17, wherein several simplified types are defined for a same original type of the structured document, the simplified types having different attributes.

23. The compression device according to claim 17, wherein a derived type based on an original type and comprising an optional set of attributes including optional attributes of the original type is defined, the compression device being configured to replace the original type of each element of the structured document having the original type with the derived type.

24. A decompression device for decompressing a structured document in the form of a binary stream, the structured document having a tree-like structure comprising information elements nested in each other and each associated with an element type identifier referencing a structure of the information element, each element comprising according to the type of the element attributes defined by a name and a value, and a value field which may comprise one or more elements,
at least one element having a simplified type derived from an original type and comprising only a part of attributes and value field of the original type, the values of the attributes and value field not belonging to the simplified type being given by a previous element in the document having the original type.

25. The decompression device according to claim 24, wherein the binary stream comprises a binary encoded value for each element of the structured document, each element binary encoded value comprising:
a binary number indicating the type identifier of the element, and
a compressed binary value encoding the value of each of the attributes of the element and the value field of the element, comprising for each optional attribute and value field of the element a bit indicating whether each attribute and the value field of the element is present or not.

26. The decompression device according to claim 25, comprising a decoder configured to decode the binary stream by converting the binary numbers and values into element type identifiers, attribute names and values, and element values.

27. The decompression device according to claim 24, configured to replace each simplified type identifier in the document with the corresponding original type identifier, and insert in each element having the simplified type identifier attributes and value of a previous element having the original type, that do not belong to the simplified type.

28. The decompression device according to claim 27, configured to replace the simplified type identifiers with the corresponding original type after decoding the binary stream.

29. The decompression device according to claim 24, wherein the simplified type comprises attributes whose presence or value is varying frequently in the elements of the original type in the document.

30. The decompression device according to claim 24, wherein several simplified types are defined for a same original type of the structured document, the simplified types having different attributes.

31. The decompression device according to claim 24, wherein at least one element has an original type replaced with a derived type comprising an optional set of attributes including optional attributes of the original type, the binary stream encoding the document comprising for each element having the derived type a bit indicating whether one or more attributes of the optional attribute set is present or absent in the element.

32. The decompression device according to claim 31, configured to replace the derived type identifier by the corresponding original type identifier.
